(19) United States
(12) Patent Application Publication
(10) Pub. No.: US 2008/0309587 A1
(43) Pub. Date: Dec. 18, 2008

(54) Head mount display

(75) Inventors: Nobuyuki Miyake, Hiratuka-shi (JP); Kenzo Chiaki, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/222,419

(22) Filed: Aug. 8, 2008

Related U.S. Application Data
(63) Continuation of application No. PCT/JP2007/054338, filed on Mar. 6, 2007.

(30) Foreign Application Priority Data
Mar. 8, 2006 (JP) 2006-062376

(51) Int. Cl. G09G 5/00

(52) U.S. Cl. 345/8

(57) ABSTRACT

A head mount display having a display part rotatable relative to a head mount band, which is improved in portability and in which the display part can be protected. A restraint part (170) is provided on the outside of the head mount band (110). The restraint part (170) is provided with a holding part (173) for holding an arm part (150) connected to the display part (160).

### TECHNICAL FIELD

The present invention relates to a head mounted display.

### BACKGROUND ART

Conventionally, a head mounted display has been used as a device for displaying an image in front of one or each eye of a user.

A conventional head mounted display is equipped with an arm having a display on the forward end thereof, in such a manner as rotatable relative to the head mounted band that is to be mounted on the head of the user (e.g., see Patent document 1).

[Patent document 1]

Japanese Patent Laid-open Publication No. 2004-80679

### DISCLOSURE OF THE INVENTION

### Problem to be Solved by the Invention

The conventional head mounted display has the display part being installed in such a manner as rotatable relative to the head mounted band. Therefore, the display part is apt to move when carried in a bag or the like, not only deteriorating portability of the head mounted display, but also a display surface of the display part is likely to be scratched.

The present invention has been made in view of the problems found in the conventional art as described above, and an object of the present invention is to provide a technique to restrain the rotational movement of the display part, which is designed to be rotatable relative to the head mounted band.

### Means to Solve the Problem

A head mounted display of a first aspect of the present invention to solve the problems above, includes, a head mounted band wearable on a head, and a display part being installed in such a manner as rotatable relative to the head mounted band, characterized in that a locking means is provided for locking the rotational movement of the display part when the display part is located at a position opposed to a top of the head or in proximity thereto of the head mounted band.

The head mounted display of a second aspect of the present invention according to the head mounted display of the first aspect includes, a cam groove provided on an housing of a speaker, and a cam follower provided on an arm part so as to be engaged with the cam groove, characterized in that the locking means is a vertical slide groove portion of the cam groove extending toward a rotation center of a support part 140, for guiding displacement of the arm part in the direction in which a distance between the display part and the head mounted band becomes narrower, when the display part is located at a position opposed to the top of the head or in proximity thereto of the head mounted band.

The head mounted display of a third aspect of the present invention according to the head mounted display of the first aspect includes a speaker at least one end of the head mounted band, characterized in that the locking means is a restraint part provided on the speaker.

The head mounted display of a fourth aspect of the present invention according to the head mounted display of the first aspect, is characterized in that the locking means is provided on a rotation control part for moving the display part rotationally.

The head mounted display of a fifth aspect of the present invention according to the head mounted display of the first aspect, is characterized in that the locking means is a restraint part provided on the head mounted band.

The head mounted display of a sixth aspect of the present invention according to the head mounted display of the third aspect or the fifth aspect is provided with an arm part that is equipped with the display part on one end, and the other end of the arm part is rotatable relative to the head mounted band, characterized in that the restraint part has a fitting part in a path of the arm part that moves rotationally, for fitting a portion of the arm part into the restraint part.

The head mounted display of a seventh aspect of the present invention according to the head mounted display of any one of the third aspect to the sixth aspect, characterized in that the restraint part restrains the rotational movement of the display part at a position where the display part and the head mounted band are opposed to each other.

The head mounted display of an eighth aspect of the present invention according to the head mounted display of the fifth aspect is provided with an arm part that is equipped with the display part on one end, and the other end of the arm part is rotatable relative to the head mounted band, a distance between the display part and the head mounted band being changeable, characterized in that the display part is moved rotationally relative to the head mounted band so as to be brought closer to the head mounted band at a position where the display part and the head mounted band are opposed to each other, thereby allowing the restraint part to restrain the rotational movement of the display part.

The head mounted display of a ninth aspect of the present invention according to the head mounted display of any one of the fifth to the eighth aspects, is characterized in that the head mounted band has a storage for storing therein at least a part of the display part, and the storage forms the restraint part.

The head mounted display of a tenth aspect of the present invention according to the head mounted display of the ninth aspect, is characterized in that the storage has at least two surfaces being opposed to each other, allowing the display part to be stored between the two surfaces.

The head mounted display of an eleventh aspect of the present invention according to the head mounted display of the ninth or the tenth aspect, is characterized in that the head mounted band is formed in such a manner that at least two members are arranged side by side, and the storage is located between the two members.

The head mounted display of a twelfth aspect of the present invention according to the head mounted display of any one of the fifth to the eleventh aspects, is characterized in that the head mounted band is provided with a circuit for processing an image that is displayed in the display part.

The head mounted display of a thirteenth aspect of the present invention according to the head mounted display of any one of the fifth to the twelfth aspects, characterized in that the head mounted band is provided with a pair of speakers.

The head mounted display of a fourteenth aspect of the present invention comprises a head mounted band and a display part mounted in such a manner as rotatable relative to the head mounted band, characterized in that the head mounted band has a storage for storing at least a part of the display part therein.

### EFFECT OF THE INVENTION

According to the present invention, there is provided a locking means which locks the rotational movement of the display part, when the display part is located at a position opposed to the top of the head or in proximity thereto of the head mounted band. Therefore, it is possible to restrain the rotational movement of the display part.

### BRIEF DESCRIPTION OF DRAWINGS

FIG. 1 is a perspective view of the head mounted display 100 according to the first embodiment of the invention;

FIG. 2 is a longitudinal sectional view on line X-X′ of FIG. 1, viewed from the direction indicated by arrows;

FIG. 3 is a transverse sectional view on line Y-Y′ of FIG. 1, viewed from the direction indicated by arrows;

FIG. 4 is a longitudinal sectional view on line Z-Z′ of FIG. 1;

FIG. 5 is a schematic diagram showing a display part 160, a display circuit 130, and a controller 180;

FIG. 6 is a front view showing a modified example of an installing location of a restraint part 170;

FIG. 7 is a perspective view of a restraint part 270 relating to a modified example;

FIG. 8 is a perspective view of the head mounted display 300 according to the second embodiment of the invention;

FIG. 9 is a schematic diagram showing a display part 360, a display circuit 330, and a controller 380;

FIG. 10 is a perspective view of a head mounted band 410 and a restraint part 470 relating to a modified example;

FIG. 11 is a perspective view of a head mounted band 510 and a restraint part 570 relating to a modified example;

FIG. 12 is a perspective view of the head mounted display 600 according to the third embodiment of the invention;

FIG. 13 is a schematic diagram showing a display part 360, a display circuit 630, and a controller 380;

FIG. 14 is a perspective view of the head mounted display 700 according to the fourth embodiment of the invention;

FIG. 15 is a transverse sectional view on line U-U′ of FIG. 14, viewed from the direction indicated by arrows, when the display part 160 is located at a position opposed to the head mounted band 710;

FIG. 16 is a perspective view of the head mounted display 900 according to the fifth embodiment of the invention;

FIG. 17 is an illustration viewed from the direction indicated by the arrow A in FIG. 16;

FIG. 18 is a transverse sectional view on line B-B′ of FIG. 16, viewed from the direction indicated by arrows; and

FIG. 19 is a longitudinal sectional view on line C-C′ of FIG. 16, viewed from the direction indicated by arrows.

### DENOTATION OF REFERENCE NUMERALS

100, 300, 600, 700, 900: HEAD MOUNTED DISPLAY, 110, 310, 410, 510, 610, 710, 910: HEAD MOUNTED BAND, 120, 720, 920: SPEAKER, 130, 330, 630: DISPLAY CIRCUIT, 160, 360: DISPLAY PART, 170, 270, 370, 470, 570, 670: RESTRAINT PART

### BEST MODE FOR CARRYING OUT THE INVENTION

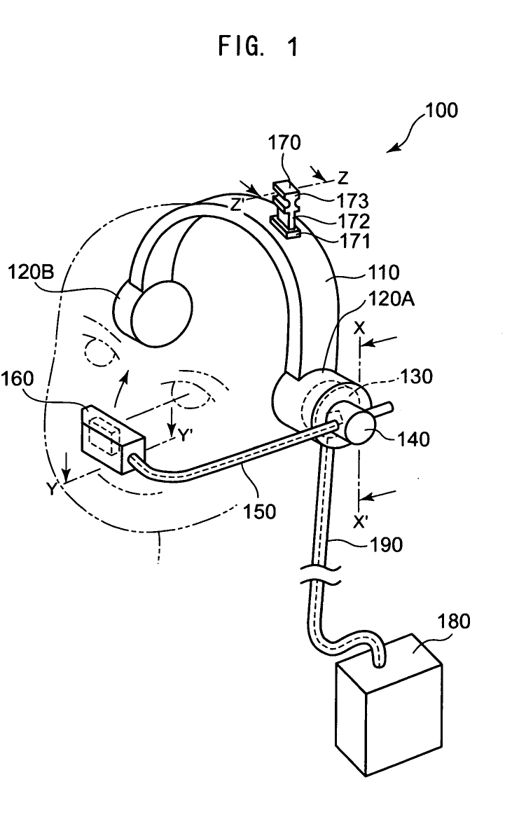

FIG. 1 is a perspective view of the head mounted display 100 according to the first embodiment of the present invention.

As illustrated, the head mounted display 100 is provided with a head mounted band 110, speakers 120A and 120B, a display circuit 130, a support part 140, an arm part 150, a display part 160, a restraint part 170, and a controller 180.

As shown in the figure, the head mounted band 110 according to the present invention is made of a band-like member having a longitudinal direction, and it is formed in a shape curved in the longitudinal direction along a user's head shape.

Here, in the present embodiment, both ends in the longitudinal direction of the head-mounted band 110 are equipped with the speakers 120A and 120B, respectively.

The head mounted band 110 according to the present invention is made of a material having a predetermined elasticity, and a distance between the speakers 120A and 120B formed on both ends of the head mounted band 110 in the longitudinal direction is made smaller than the width of the user's head. Accordingly, when mounted on the user's head, the speakers 120A and 120B installed on the both ends of the head mounted band 110 are urged toward inner side of the user's head, and thereby allowing the head mounted display 100 to be fixedly mounted on the user's head.

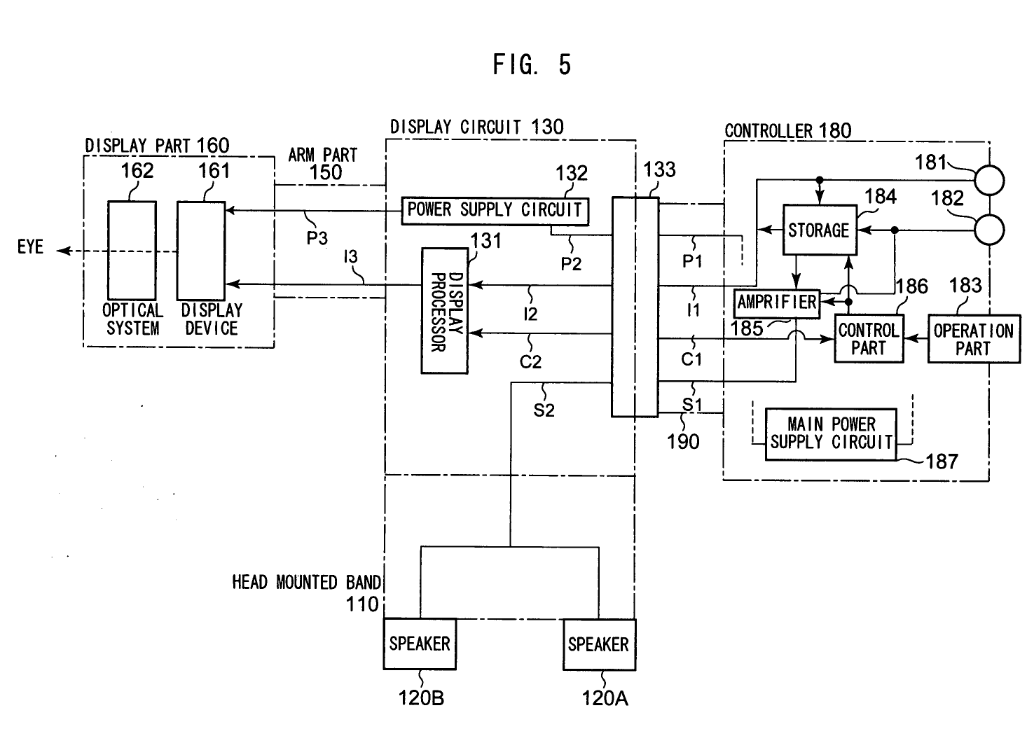

As shown in FIG. 5 (a schematic diagram of the display part 160, display circuit 130, and controller 180), the head mounted band 110 according to the present embodiment is provided with an audio signal line S2 for supplying an audio signal from the display circuit 130 to the speakers 120A and 120B.

The speakers 120A and 120B are speakers dedicated to so-called headphones, which are used by being put on both ears of the user. Here, it is possible to employ conventional speakers, and explanations thereof will not be given here.

In FIG. 1, the speaker 120A serving as a speaker for the left ear use is on the observers' right, and the speaker 120B serving as a speaker for the right ear use is on the observers' left. However, the settings of the speakers 120A and 120B regarding the left ear use and the right ear use are configured to be changeable, by inputting a predetermined directive from the user via the operation part 183 of the controller 180, which will be described below.

In the present embodiment, the housing 121 of the speaker 120A on the observer's right in FIG. 1 incorporates the display circuit 130.

As shown in FIG. 5, the display circuit 130 is provided with a display processor 131 for transmitting an image signal to a display device 161, a power supply circuit 132 for supplying electric power to the display processor 131 and the display device 161, and a cable connector 133 for connecting a cable 190.

The cable connector 133 is connected to the controller 180, which will be described below, via a power line P1, an image signal line I1, a control signal line C1, and an audio signal line S1. Power supplied from the power line P1 is transmitted to the power supply circuit 132, an image signal supplied from the image signal line I1 and a control signal supplied from the control signal line C1 are transmitted to the display processor 131, and an audio signal supplied from the audio signal line S1 is transmitted to the speakers 120A and 120B.

In the present embodiment, the support part 140 is coupled, being rotatable, with the housing 121 of the speaker 120A on the observer's right side in FIG. 1.

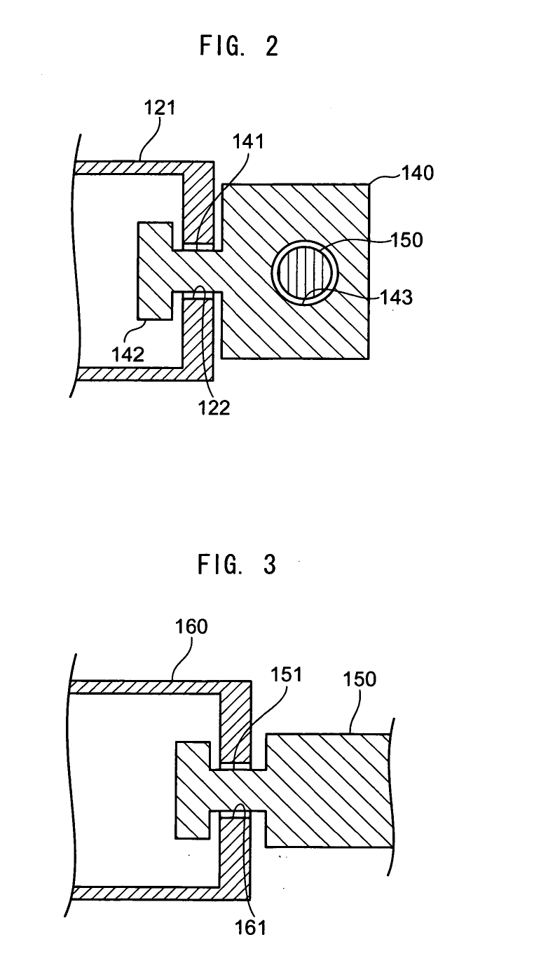

In other words, as shown in FIG. 2 (a longitudinal sectional view on line X-X′ of FIG. 1, viewed from the direction indicated by arrows), a columnar axial member 141 is provided on the support part 140, and the axial member 141 is inserted in a columnar through-hole 122 provided on the housing 121 of the speaker 120A, whereby the support part is coupled in such a manner as rotatable.

A flange 142 is provided within the housing 121 of the speaker 120A, on the tip of the axial member 141, thereby preventing the support 140 from being detached from the housing 121.

Here, it is desirable to design an inner diameter of the through-hole 122 and an outer diameter of the axial member 141 appropriately, so that a predetermined friction torque is generated between the through-hole 122 and the axial member 141. It is further possible to place a frictional member between the through-hole 122 and the axial member 141, so that a predetermined friction torque is generated therebetween.

The arm part 150 is slidably coupled with the support part 140.

As shown in FIG. 2, the support part 140 is provided with a columnar through-hole 143, for instance. The arm part 150 penetrates into the through-hole 143, whereby the support part 140 and arm part 150 are coupled slidably.

Here, it is desirable to design an inner diameter of the through-hole 143 and an outer diameter of the arm part 150 appropriately, so that a predetermined friction torque is generated between the through-hole 143 and the arm part 150. It is further possible to place a frictional member between the through-hole 143 and the arm part 150, so that a predetermined friction torque is generated therebetween.

The sliding direction between the support part 140 and the arm part 150 is set in such a manner as allowing a distance between the display part 160 mounted on the forward end of the arm part 150 and the head mounted band 110 to be changeable. In the present embodiment, a direction approximately perpendicular to the axis line of the axial member 141 of the support part 140 is made to be the sliding direction, thereby enabling the variation of the distance between the display part 160 and the head mounted band 110.

In addition, the arm part 150 is curved in its longitudinal direction, so that the display part 160 mounted on the forward end of the arm part 150 can be set to position just in front of the user's eyes, when the head mounted band 110 is mounted on the user's head.

As shown in FIG. 5, the arm part 150 is provided with a power line P3 for supplying power from the power supply circuit 132 to the display device 161, and an image signal line I3 for supplying an image signal from the display processor 131 to the display device 161.

The display part 160 is coupled with the forward end of the arm part 150 in such a manner as rotatable.

By way of example, as shown in FIG. 3 (a transverse sectional view on line Y-Y′ of FIG. 1, viewed from the direction indicated by arrows), a columnar through-hole 161 is provided on the joint between the display part 160 and the arm part 150, and a columnar axial member 151 provided on the tip of the arm part 150 is inserted in the through-hole 161, whereby the display part 160 and the arm part 150 are coupled with each other in such a manner as rotatable.

In addition, the axis line of the axial member 151 is made to follow the longitudinal direction of the arm part 150, thereby allowing the display part 160 to move rotationally in vertical direction, when the head mounted display 100 is mounted on the user's head.

As shown in FIG. 5, the display part 160 in the present embodiment includes the display device 161 for displaying an image based on the image signal supplied from the display processor 131, an optical system 162 for changing emitting direction of the image being displayed on the display device 161.

The restraint part 170 is formed on the outer side of the head mounted band 110 when the head mounted display 100 is mounted on the user's head. In other words, the restraint part 170 is formed on the outer side of the curved surface of the head mounted band 110.

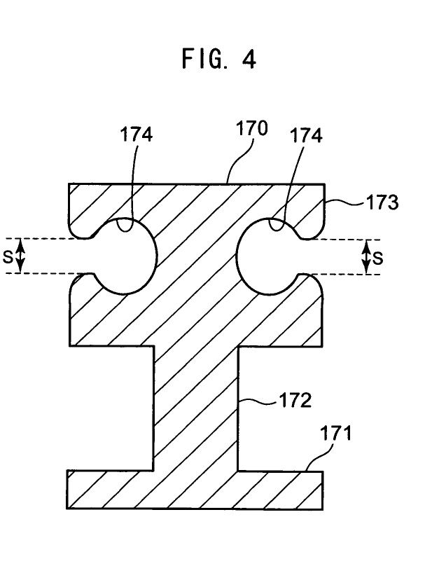

Here, as shown in FIG. 4 (a longitudinal sectional view on line Z-Z′ of FIG. 1, viewed from the direction indicated by arrows), the restraint part 170 in the present embodiment is provided with a base part 171 attached on the head mounted band 110, a strut part 172 extending from the base part 171 to the outside of the head mounted band 110, and a fitting part 173 formed on the tip of the strut part 172.

The base part 171 is a portion used as a base for mounting the restraint part 170 onto the head mounted band 110. A publicly known method such as bonding and welding may be employed as a method for attaching the base part 171 on the head mounted band 110. Alternatively, these elements may be formed in one piece.

The strut part 172 serves as a spacer to allow a predetermined spacing between the base part 171 and a fitting part 173, and the strut part 172 is not necessarily required to be provided.

As shown in FIG. 4, the fitting part 173 is provided with two concave parts 174 that open to the direction of the path taken by the arm part 150 moving rotationally, on the both sides of the extending direction of the strut part 172 from the base part 171.

Here, the concave part 174 has a size and shape allowing the arm part 150 to be inserted into the internal space of the concave part, and the shortest distance S of the opening is designed to be smaller than the diameter of the arm part 150.

At least the fitting part 173 is made of a material having a predetermined elasticity, whereby the opening of the concave part 174 is deformed elastically so as to insert the arm part 150 into the inner space of the concave part 174. In addition, when the arm part 150 is taken out from the inner space of the concave part 174, the opening of the concave part 174 is deformed elastically.

As thus described, since the shortest distance S of the concave part 174 for fitting the arm part 150 therein is formed in such a manner as being smaller than the diameter of the arm part 150, it is possible to prevent the arm part 150 being inserted inside the concave part 174 from being detached easily.

Here, it is desirable that the arm part 150 adheres tightly to the inner surface of the concave part 174, thereby restricting the movement of the arm part 150 being inserted within the concave part 174.

It is to be noted that there are provided two concave parts 174, because this configuration allows the arm part 150 to fit into the restraint part 170 from any of the either direction.

The controller 180 is connected to the display circuit 130 placed within the housing 121 of the speaker 120A, via the cable 190, and controls the speakers 120A and 120B, and the display part 160.

As shown in FIG. 5, the controller 180 in the present embodiment is provided with an image signal receiving end 181 for receiving an image signal from the outside, an audio signal receiving end 182 for receiving an audio signal from the outside, an operation part 183 for a user to input a predetermined directive, a storage 184 for storing the image signal and the audio signal, an amplifier 185 for amplifying the audio signal, a control part 186 for generating a control signal in each part according to the directive inputted via the operation part 183, and a main power supply circuit 187.

The head mounted display 100 relating to the present embodiment, which is configured as described above, is used as the following.

Firstly, when the head mounted display 100 is carried, the arm part 150 is moved rotationally about the axial member 141 of the support part 140, and the arm 150 is fitted into the concave part 174 of the restraint part 170 formed on the head mounted band 110, so as to fix the arm part.

When viewing an image and listening to audio data are performed by using the head mounted display 100, the head mounted band 110 is put on the user's head in such a manner that the speakers 120A and 120B are placed on the user's ears, respectively.

Then, the arm part 150 is detached from the concave part 174 of the restraint part 170 formed on the head mounted band 110, and the arm part 150 is moved rotationally and adjusted so that the display part 160 is positioned just in front of the user's each eye.

In addition, since the display part 160 itself is designed to be rotatable about the arm part 150, the display part 160 is rotated in up and down direction and adjustment so as to establish an angle which allows easier viewing of an image outputted from the display part 160 is performed.

Then, when the user inputs a directive for reconstructing an image and replaying an audio data via the operation part 183 of the controller 180, the user views the image and listens to the audio data respectively received from the image signal receiving end 181 and the audio signal receiving end 182 of the controller 180, via the display part 160 and the speakers 120A and 120B.

In FIG. 1, the display part 160 is positiond just in front of the left eye of the user, the speaker 120A is placed on the left ear, and the speaker 120B is placed on the right ear. However, for example, the display part 160 may be rotated together with the arm part 150 by 180 degrees about the support part 140, whereby it is possible to configure such that the display part 160 is positiond just in front of the right eye of the user, the speaker 120A is placed on the right ear, and the speaker 120B is placed on the left ear. In the case above, it is necessary to turn upside down the image displayed in the display part 160, and invert the left and right directions of the audio signals transmitted to the speakers 120A and 120B. In the present embodiment, the user inputs such inverting direction in the operation part 183 of the controller 180, and thereby allowing the control part 186 to turn the image signal upside down, and invert the left and right directions of the audio signals.

Further, when the user stops viewing the image and listening to the audio data by using the head mounted display 100, the display part 160 is moved rotationally together with the arm part 150, and the arm part 150 is fitted into the concave part 174 of the fitting part 170 formed on the head mounted band 110. Accordingly, the display part 160 is held fixedly at a position out of the front area of the user's eye, thereby avoiding interruptions of the user's view.

In addition, when the user finishes viewing the image and listening to the audio data by using the head mounted display 100, the head mounted band 110 is removed out of the user's head, and the display part 160 is moved rotationally together with the arm part 150 to fit the arm part 150 into the concave part 174 of the restraint part 170 that is formed on the head mounted band 110. Accordingly, it is possible to restrain the display part 160 and the arm part 150 from freely moving rotationally about the support part 140.

As thus described, since it is possible to restrain the display part 160 and the arm part 150 from freely moving rotationally, even when the head mounted display 100 is put into a bag or the like, the display part 160 and the arm part 150 are restrained from freely moving rotationally in the bag or the like. Therefore, this enhances portability and prevents the display part 160 from being scratched or damaged.

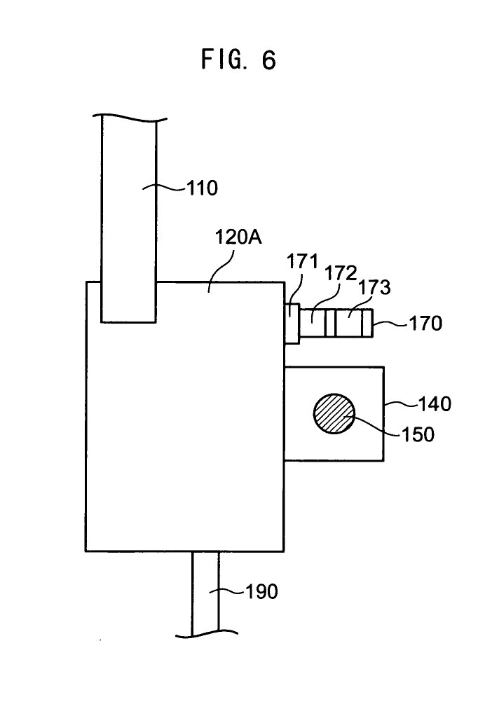

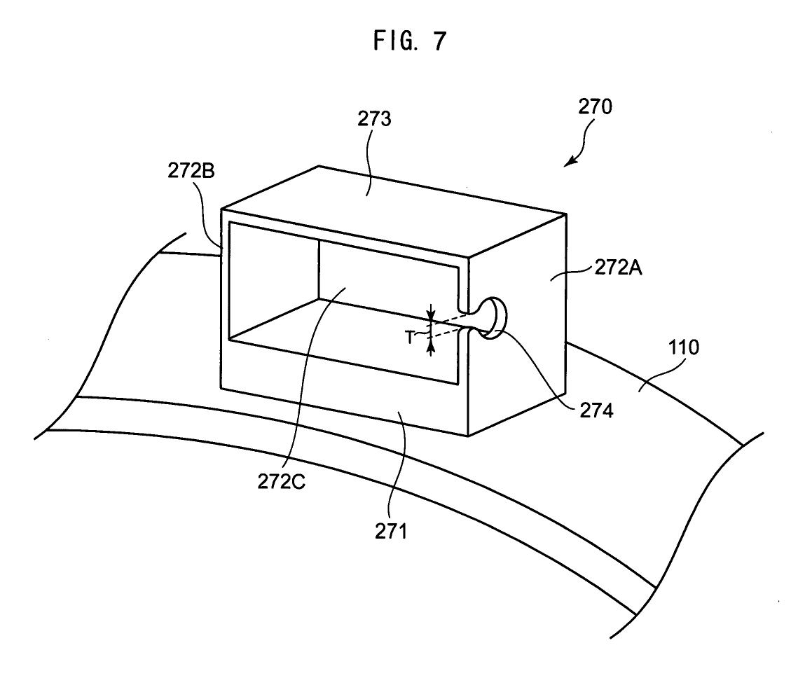

In the embodiment as described above, the restraint part 170 is provided on the head mounted band 110. However, the present invention is not limited to this example. As shown in FIG. 6, it is further possible to provide the restraint part 170 on the speaker 120A, for instance.

Also in the case above, the fitting part 173 of the restraint part 170 is located on the rotation path of the arm part 150, thereby allowing the arm part 150 to be held fixedly.

Next, with reference to FIG. 7, there will be explained a modified example of the restraint part 170 of the present embodiment.

As shown in FIG. 7, a restraint part 270 relating to this modified example is provided with a storage that is made up of a bottom surface 271, three side planes 272A, 272B, and 272C extending from the rim of the bottom surface 271, and an upper surface 273 connected to the upper ends of the three side planes 272A, 272B, and 272C. The restraint part 270 is coupled with the head mounted band 110 via the bottom surface 271 of the storage.

It is to be noted here that there are formed three side planes 272A, 272B, and 272C from the bottom surface 271, and a side plane is not provided on one face which is opposed to the rotation path of the display part 160. By creating an opening on one face opposed to the rotation path of the display part 160 as such, it is possible to put the display part 160 from this opened face, into the space surrounded by the bottom surface 271, the side planes 272A, 272B, and 272C, and upper surface 273.

The size and the shape of the space surrounded by the bottom surface 271, the side planes 272A, 272B, and 272C, and the upper surface 273 may be designed appropriately within the range of the space that allows the display part 160 to be put therein.

As for the orientation of the display part 160 upon stored in the space surrounded by the bottom surface 271, the side planes 272A, 272B, and 272C, and the upper surface 273, it is desirable to store the display part 160 in such a manner that a surface of the display part 160 for displaying an image is opposed to the side plane 272C, which is opposed to the rotation path of the display part 160.

Among the three side planes 272A, 272B, and 272C, the side plane 272A being located adjacent to the speaker 120A that is connected to the arm part 150, is provided with a concave part 274 that opens to the direction of the rotation path of the arm part 150.

Here, the concave part 274 has a size and shape allowing the arm part 150 to be inserted in its internal space, and a shortest distance T of the opening of the concave part 274 is formed in such a manner as being smaller than the diameter of the arm part 150.

Then, at least the side plane 272A on which this concave part 274 is provided is formed by a material having a predetermined elasticity, whereby the opening is elastically deformed. Accordingly, the arm part is allowed to be inserted into the concave part 274, and similarly, when taking out the arm part 150 from the inside of the concave part 274, this opening is elastically deformed.

As thus described, the shortest distance T of the opening of the concave part 274 for inserting the arm part 150 therein is formed in such a manner as being smaller than the diameter of the arm part 150. Therefore, it prevents the arm part 150 inserted inside the concave part 274 from easily detached therefrom.

It is desirable here that the inner surface of the concave part 274 is tightly adhered to the arm part 150, so as to restrict the movement of the arm part 150 that is inserted in the concave part 274.

As thus described, the restraint part 270 relating to the present modified example stores the display part 160 inside the restraint part 270, and this configuration allows the restraint part 270 to cover the display part 160. Therefore, when the head mounted display 100 is carried, it is possible to prevent the display part 160 from being scratched or damaged.

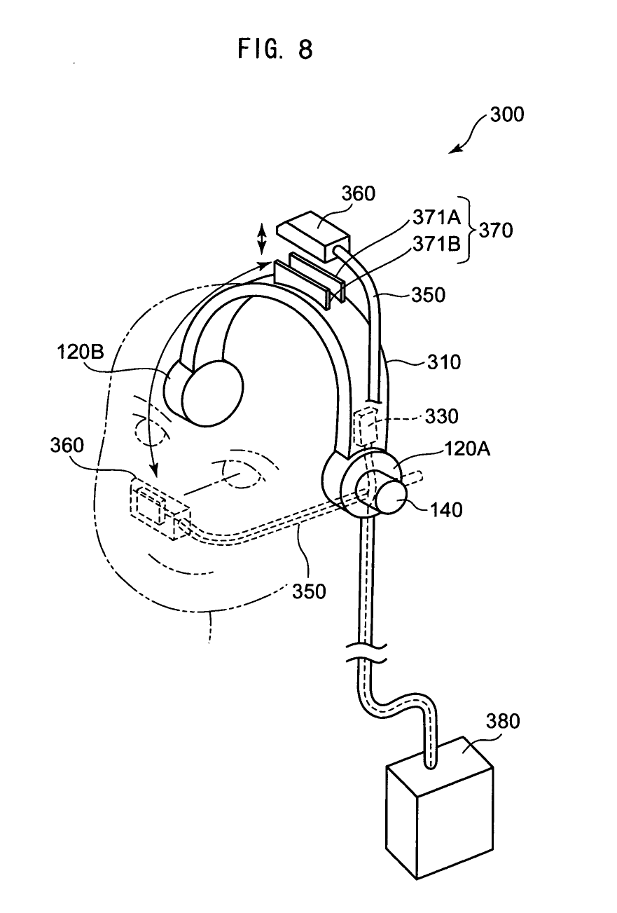

FIG. 8 is a perspective view of a head mounted display 300 according to a second embodiment of the present invention.

As illustrated, the head mounted display 300 relating to the present embodiment is provided with a head mounted band 310, speakers 120A and 120B, a display circuit 330, a support part 140, an arm part 350, a display part 360, a restraint part 370, and a controller 380. Since the head mounted band 310, the display circuit 330, the arm part 350, the display part 360, the restraint part 370, and the controller 380, are different from those of the first embodiment, explanations will be made as to the points relating to the differences.

As illustrated, the head mounted band 310 in the present embodiment is provided with the display circuit 330, unlike the first embodiment.

Any position may be selected as a position for installing the display circuit 330 on the head mounted band 310. However, it is desirable to install the display circuit at a position adjacent to the speaker 120A on which the support part 140 being coupled to the arm part 350 is provided, since a length of wiring can be made shorter.

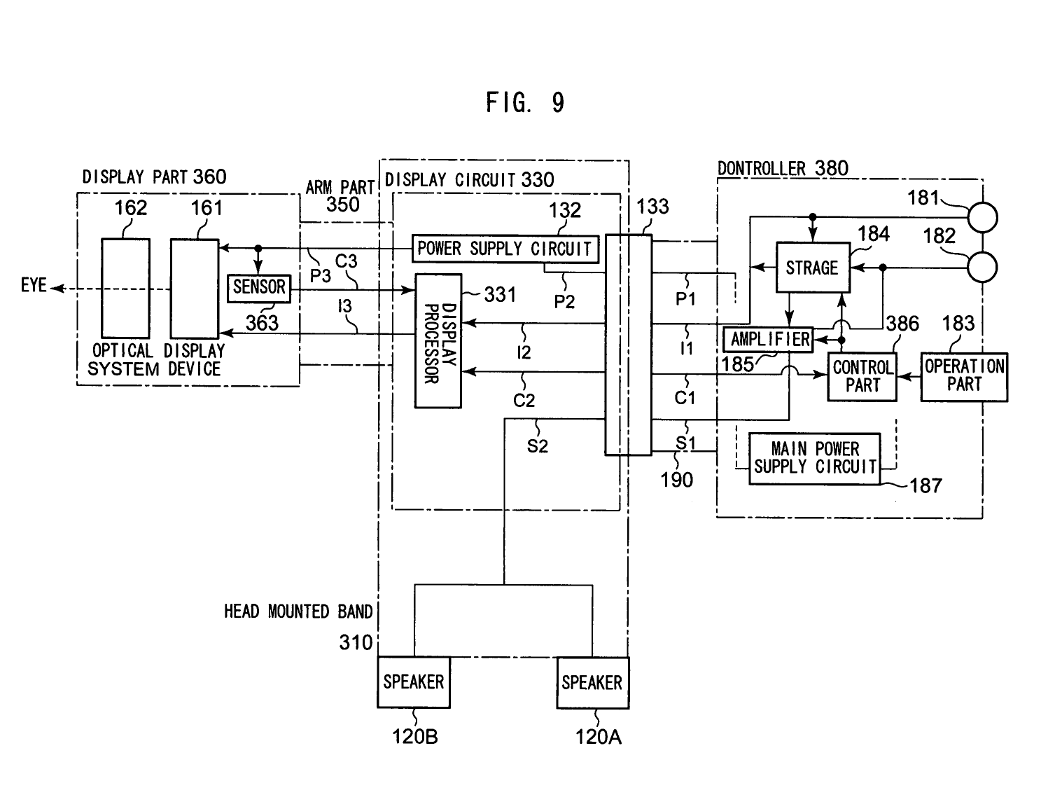

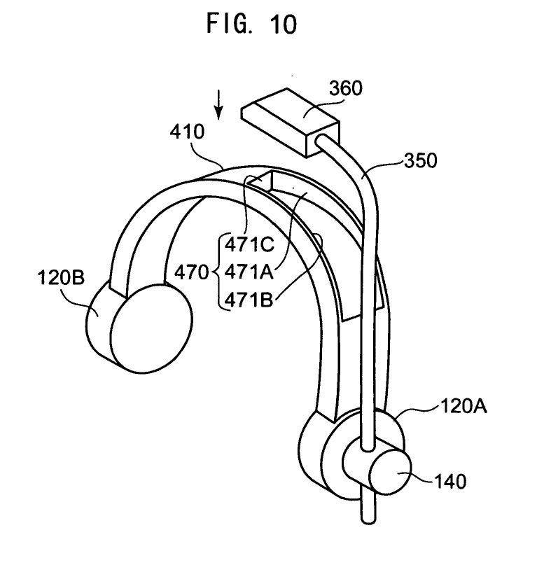

In addition to the processing performed in the first embodiment, a display processor 331 of the display circuit 330 according to the present embodiment performs a processing for receiving a signal from a sensor 363 provided in the display part 360 and transmitting the signal to the controller 380. Therefore, as shown in FIG. 9 (a schematic diagram of the display part 360, the display circuit 330, and the controller 380), the arm part 350 of the present embodiment is provided with a control signal line C3 for transmitting the signal from the sensor 363 to the display processor 331.

As shown in FIG. 9, the display part 360 relating to the present embodiment incorporates the sensor 363, unlike the first embodiment.

Any sensor is available as the sensor 363, as far as it is capable of detecting top and bottom of the display part 360. In the present embodiment, a gravity sensor is employed.

A detection signal detected by the sensor 363 is transmitted to the display processor 331 of the display circuit 330, and further transmitted from the display processor 331 to the control part 386 of the controller 380.

The restraint part 370 relating to the present embodiment is made up of two sidewalls 371A and 371B being opposed to the rotation path of the display part 360. In other words, these sidewalls 371A and 371B are arranged side by side, so as to be approximately parallel in the longitudinal direction of the head mounted band 310, allowing the display part 360 to be placed therebetween.

It is desirable here that these side walls 371A and 371B are made of a material having a predetermined elasticity, and a distance therebetween is formed to be slightly smaller than the width of the display part 360. With the configuration above, when these sidewalls 371A and 371B are deformed elastically to place the display part 360 therebetween, the display part 360 is held fixedly by the urging force of the sidewalls 371A and 371B.

As for the orientation of the display part 360 upon placed between the sidewalls 371A and 371B, it is desirable that a surface for displaying an image of the display part 360 is opposed to the head mounted band 310. By placing the display part 360 with the orientation as described above, the image displaying surface of the display part 360 is covered by the head mounted band 310, whereby it is possible to prevent the image displaying surface from being scratched.

Here, when the display part 360 is placed between the sidewalls 371A and 371B, the arm part 350 is firstly moved rotationally about the support part 140, so as to position the display part 360 above and between the sidewalls 371A and 371B. After positioning as such, the arm part 350 is made to slide toward the support part 140, to displace the display part 360 heading in the direction of the head mounted band 310.

The control part 386 in the controller 380 in the present embodiment receives a signal obtained from the sensor 363 of the display part 360, identifies the top and bottom orientation of the display part 360, and controls the image signal to be transmitted to the display part 360 according to the up and bottom information. The control part further controls left and right directions of the audio signals to be transmitted to the speakers 120A and 120B, in conjunction with the top and bottom information of the image signal to be transmitted to the display part 360.

By way of example, as illustrated in FIG. 8, when the display part 360 is positioned in front of the user's left eye, the speaker 120A is placed on the left ear and the speaker 120B is placed on the right ear. Therefore, the control part performs controls so as to transmit the audio signals to the appropriate ears respectively.

On the other hand, when the display part 360 is moved rotationally together with the arm part 350 by approximately 180 degrees about the support part 140, the display part 360 is positioned in front of the user's right eye, and the image displayed in the display part 360 is flipped vertically. In this case, the speaker 120A is placed on the right ear, and the speaker 120B is placed on the left ear. Therefore, the audio signals transmitted to the speakers 120A and 120B are also inverted horizontally.

As described above, according to the head mounted display 300 relating to the present embodiment, in addition to the effect exerted by the first embodiment, since the display circuit 330 is provided in the head mounted band 310, it is possible to make the left and right speakers 120A and 120B to have approximately the same shape, not only achieving a good appearance, but also acquiring a symmetrical acoustic property.

In addition, the head mounted band 310 becomes relatively wide for the purpose of installing the restraint part 370 on the head mounted band 310. Therefore, the configuration to provide the display circuit 330 in the head mounted band 310 allows an effective use of the head mounted band 310 having such increased width.

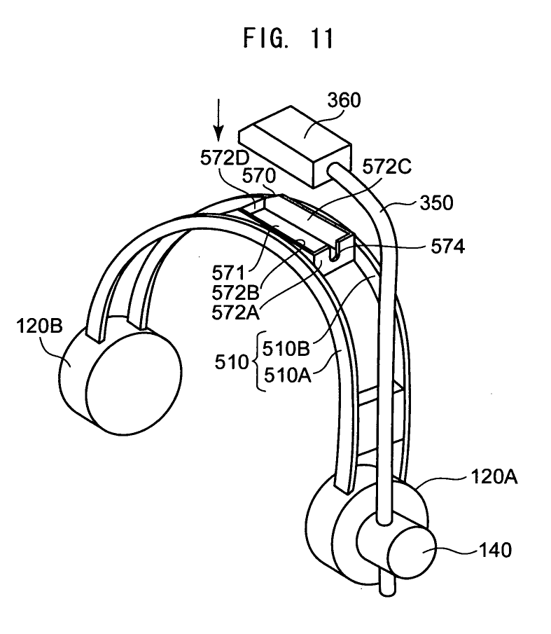

Next, with reference to FIG. 10 and FIG. 11, there will be explained a modified example of the head mounted band 310 and the restraint part 370 according to the present embodiment.

FIG. 10 is a perspective view of a head mounted band 410 and a restraint part 470 relating to the modified example of the present embodiment.

In the modified example, a concave part on the head mounted band 410 for fitting the display part 360 therein is formed as a restraint part 470. The display part 360 is stored within this concave part that is made up of wall members 471A, 471B, and 471C, and thereby holding the display part 360 fixedly, in the similar manner as the second embodiment.

The head mounted band 410 is made of a material having a predetermined elasticity and it is formed in such a manner that a distance between at least the wall members 471A and 471B becomes slightly smaller than the width of the display part 360. With this configuration, when the display part 360 is placed between these wall members, it allows the display part 360 to be held fixedly.

As for the depth of the concave part made up of these wall members 471A, 471B, and 471C, it is desirable that the height of the display part 360 is the same as the depth of the wall members 471A, 471B, and 471C, when the display part 360 is fitted therein. In other words, it is desirable that the outer surface of the head mounted band 410 forms the same plane as the surface of the display part 360, and no gap is generated therebetween when the display part 360 is fitted therein.

As shown in the modified example, the concave part for fitting the display part 360 therein is formed on the head mounted band 410, and thereby avoiding protrusion of the display part 360 from the head mounted band 410, when the display part 360 is fitted into the head mounted band 410. Therefore, it is possible to prevent the display part 360 from being scratched, as well as saving space, enhancing portability, and achieving a good appearance.

FIG. 11 is a perspective view of a head mounted band 510 and a restraint part 570 relating to an alternative modified example according to the present embodiment.

In this modified example, a first member 510A and a second member 510B forming the head mounted band 510 are arranged side by side so as to be approximately in parallel with each other, and the restraint part 570 is placed between the members 510A and 510B being arranged.

Here, the restraint part 570 of the present modified example is formed by a storage which is made up of a bottom surface 571, four side planes 572A, 572B, 572C, and 572D extending from the rim of the bottom surface 571. A space surrounded by the bottom surface 571, and the side planes 572A, 572B, 572C, and 572D is designed in such a manner that the display part 360 can be stored therein.

The size and the shape of the space surrounded by the bottom surface 571, the side planes 572A, 572B, 572C, and 572D may be designed appropriately within the range of the space that allows the display part 360 to be stored therein.

As for the orientation of the display part 360 when it is stored in the space surrounded by the bottom surface 571, the side planes 572A, 572B, 572C, and 572D, it is desirable that a surface for displaying an image of the display part 360 is opposed to the bottom surface 571.

The side plane 572A among the four side planes 572A, 572B, 572C, and 572D, which is located being adjacent to the speaker 120A that is connected to the support part 140 coupled with the arm part 350, is provided with a concave part 574 that opens toward the upper edge of the side plane 572A.

Here, the concave part 574 has a size and shape that allows the arm part 350 to be fitted into the space therein. In other words, the concave part 574 is formed in such a manner as having a width approximately the same as the diameter of the arm part 350. Accordingly, when the arm part 350 is fitted into the concave part 574, the concave part 574 is brought into contact with the arm part 350, and frictional force therebetween allows the concave part 574 to hold the arm part 350 fixedly.

As thus described, the diameter of the arm part 350 and the width of the concave part 574 are formed to have approximately the same size, and the friction is generated therebetween, whereby the arm part 350 is prevented from easily detached from the concave part 574 where the arm part is fitted in.

As thus described, the restraint part 570 of the present modified example stores the display part 360 therein, and covers the display part 360. Therefore, when the head mounted display is carried, it is possible to prevent the display part 360 from being scratched or damaged. In addition, since the restraint part 570 is arranged between the first member 510A and the second member 510B that constitute the head mounted band 510, this structure saves space and enhances the portability.

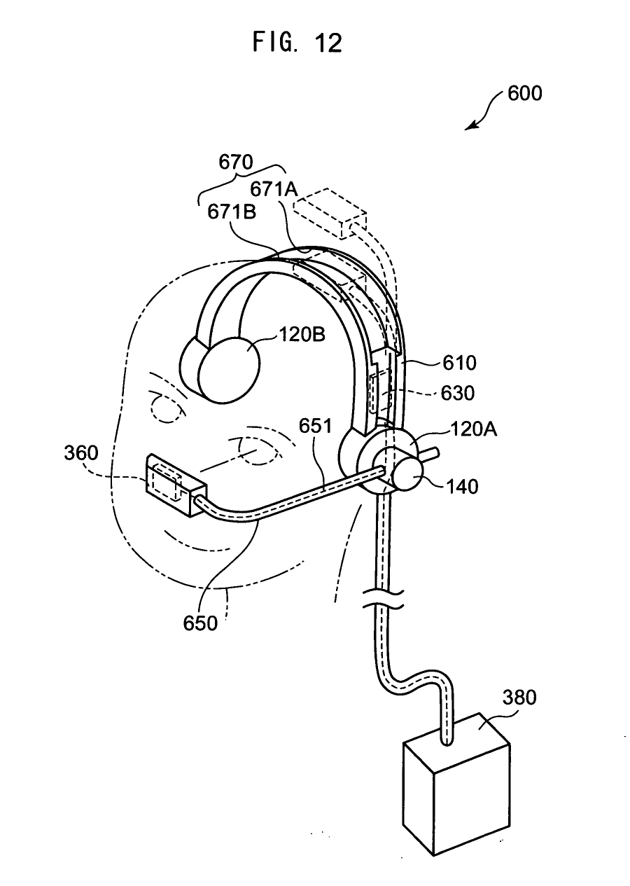

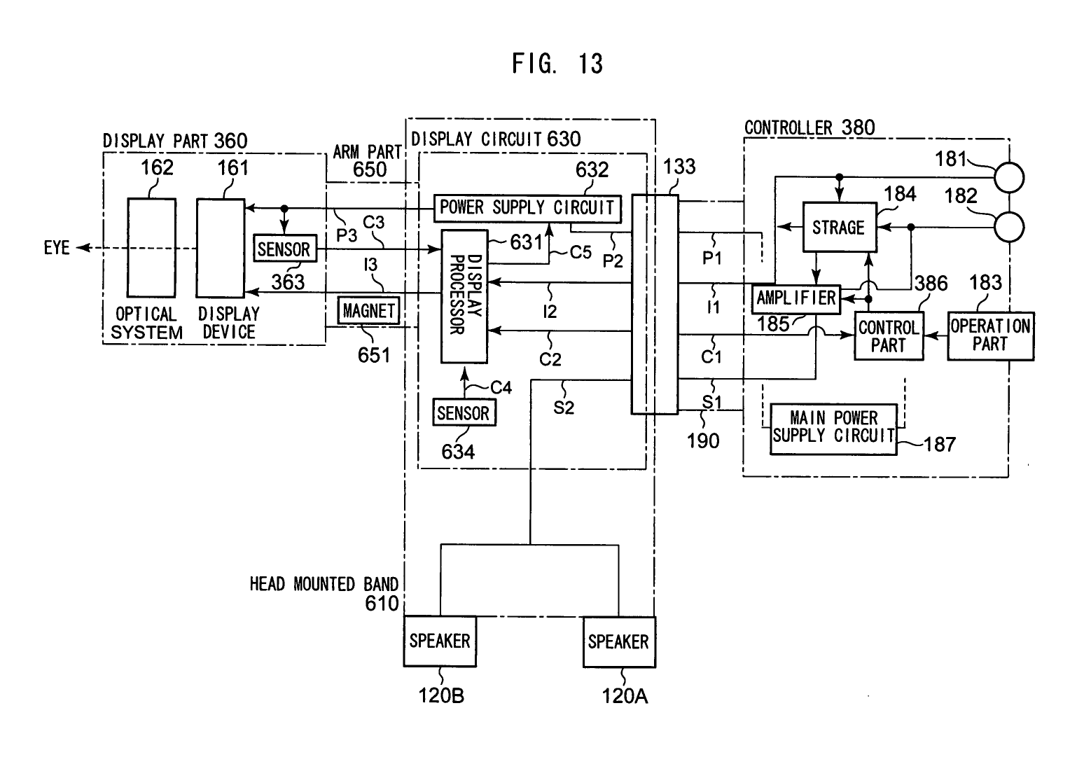

FIG. 12 is a perspective view of a head mounted display 600 according to a third embodiment of the present invention.

As illustrated, the head mounted display 600 relating to the present embodiment is provided with a head mounted band 610, speakers 120A and 120B, a display circuit 630, a support part 140, an arm part 650, a display part 360, a restraint part 670, and a controller 380. Since the head mounted band 610, the display circuit 630, the arm part 650, and the restraint part 670 are different from those of the second embodiment, explanations will be made as to the points relating to the differences.

As shown in the figure, the head mounted band 610 according to the present embodiment is provided with the display circuit 630, unlike the second embodiment.

As for the position where the display circuit 630 is installed on the head mounted band 610, it may be located in the same manner as the second embodiment.

Unlike the second embodiment, the display circuit 630 relating to the present embodiment is provided with a sensor 634 for detecting a position of the arm part 650. The present embodiment employs as this sensor 634, a magneto-sensor for detecting a magnetic force of the magnet 651 that is installed on the arm part 650, which will be described below.

Then, a detection signal from the sensor 634 is outputted to the display processor 631 via the control signal line C4, and it is configured in such a manner that a position of the arm part 650 can be detected by the strength of the magnetic force being detected.

Here, in the present embodiment, in addition to the processing performed in the second embodiment, when the magnetic force detected by the sensor 634 becomes stronger over a predetermined threshold, in other words, when the arm part 650 enters a predetermined range from the head mounted band 610, the display processor 631 performs a processing to issue a directive to the power supply circuit 632 via the control signal line C5 to stop supplying power to the display part 360.

It is to be noted that as for the threshold, an appropriate value may be selected within a range that allows a stop of the power supply to the display part 630 when the display part 360 is put into the restraint part 670.

The power supply circuit 632 which receives the directive to stop the power supply to the display part 360, stops the power supply to the display part 360 via a switch (not illustrated) provided on the power supply circuit 632.

On the other hand, when the magnetic force detected by the sensor 634 becomes weaker over the predetermined threshold, in other words, when the arm part 650 goes out of the predetermined range away from the head mounted band 610, the display processor 631 performs processing to issue a directive to the power supply circuit 632 via the control signal line C5 to supply power to the display part 360.

The power supply circuit 632 which receives the directive to supply power to the display part 360, supplies power to the display part 360 via the switch (not illustrated) provided on the power supply circuit 632.

The arm part 650 in the present embodiment is provided with a magnet 651. As for the position where the magnet 651 is installed, any position may be selected within a range that allows the sensor 634 provided in the display circuit 630 to detect the magnetic force of the magnet 651.

The restraint part 670 according to the present embodiment is made up of two sidewalls 671A and 671B, which are opposed to the rotation path of the display part 360. In other words, these sidewalls 671A and 671B are arranged side by side to be approximately in parallel with the longitudinal direction of the head mounted band 610, and it is designed so that the display part 360 is put between these walls being arranged.

It is desirable that these sidewalls 671A and 671B are made up of a material having a predetermined elasticity, and formed to have a distance therebetween slightly smaller than the width of the display part 360. With the configuration above, when the sidewalls 671A and 671B are elastically deformed to place the display part 360 therebetween, the display part 360 is held fixedly by the urging force from the sidewalls 671A and 671B.

As for the orientation of the display part 360 when it is placed between the sidewalls 671A and 671B, it is desirable that a surface for displaying an image of the display part 360 is opposed to the head mounted band 610. By placing the display part 360 with the orientation as described above, the surface for displaying an image of the display part 360 is covered by the head mounted band 610, thereby preventing the surface for displaying the image from being scratched.

When the display part 360 is placed between the sidewalls 671A and 671B, firstly, the arm part 650 is moved rotationally about the support part 140, and the display part 360 is located above and between the sidewalls 671A and 671B. At this position, the arm part 650 is made to slide toward the support part 140 to displace the display part 360 in the direction of the head mounted band 610.

As thus described, in the present embodiment, when the display part 360 is at a position being put in the restraint part 670, it is configured such that supplying of power to the display part 360 is stopped. Therefore, when the display part 360 is located at this position, the power supply is stopped with reliability, thereby saving power.

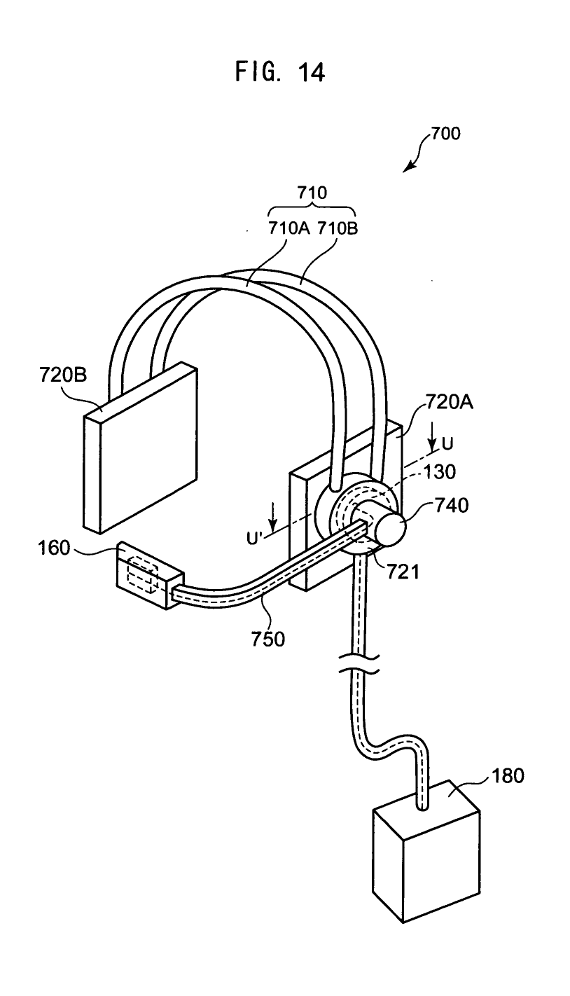

FIG. 14 is a perspective view of a head mounted display 700 as a fourth embodiment of the present invention.

As illustrated, the head mounted display 700 is provided with a head mounted band 710, speakers 720A and 720B, a display circuit 130, a support part 740, an arm part 750, a display part 160, and a controller 180.

As shown in the figure, the head mounted band 710 according to the present embodiment is formed by arranging stick-like first member 710A and second member 710B side by side approximately in parallel in the longitudinal direction, and the shape of the head mounted band is curved in the longitudinal direction along the user's head shape.

Here, both ends of the head mounted band 710 in the longitudinal direction are provided with the speakers 720A and 720B, respectively.

As for the speakers 720A and 720B in the present embodiment, only the shape of the housing 721 is different and other elements are identical, if compared with the first embodiment.

In the present embodiment, the speaker 720A on the observer's right side in FIG. 14 is provided with the display circuit 130.

Since the display circuit 130 has the same configuration as the first embodiment, tedious explanation will not be given here.

In the present embodiment, the support part 740 is rotatably coupled with the housing 721 of the speaker 720A on the observer's right side in FIG. 14.

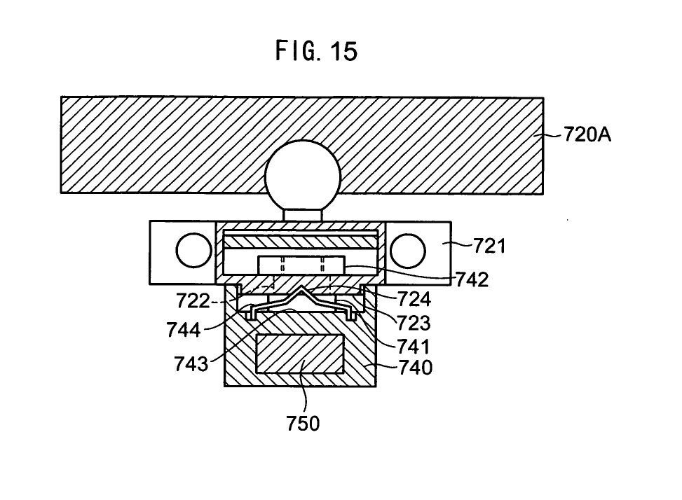

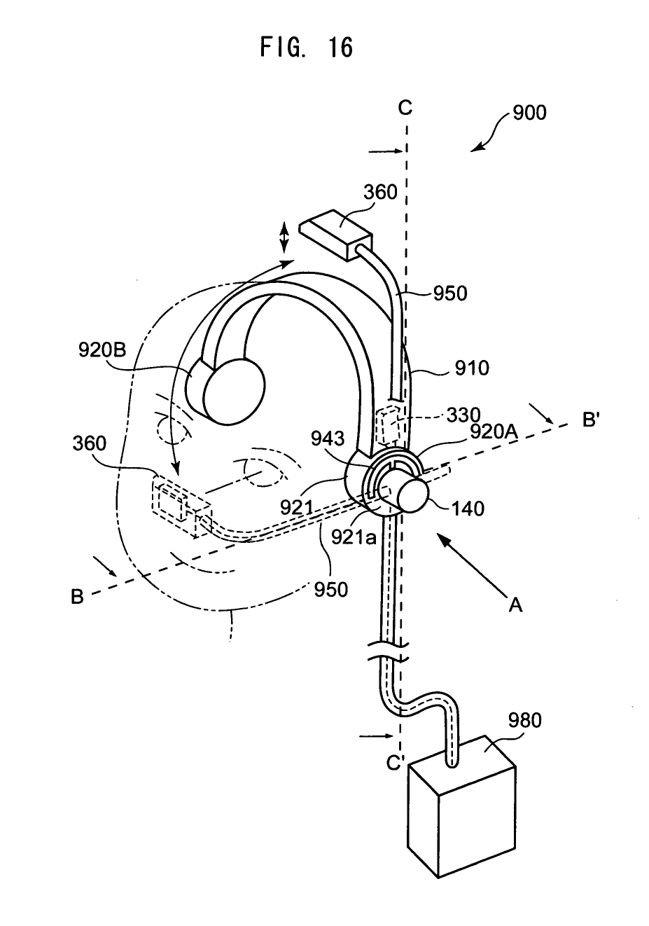

For example, as shown in FIG. 15 (a transverse sectional view on line U-U′ of FIG. 14 viewed from the direction indicated by arrows, when the display part 160 is located at a position opposed to the head mounted band 710), the support part 740 is provided with a columnar axial member 741, and the axial member 741 is inserted into a columnar through-hole 722 provided on the housing 721, so as to be rotatably coupled with each other.

The tip of the axial member 741 is provided with a flange 742 within the housing 721, and thereby preventing the support part 740 from being detached from the housing 721.

It is desirable here to design appropriately the inner diameter of the through-hole 722 and the outer diameter of the axial member 741, so that a predetermined friction torque is generated between the through-hole 722 and the axial member 741. In order to generate such friction torque between the through-hole 722 and the axial member 741, it is further possible to put a frictional member therebetween.

The support part 740 is provided with a lock part 744 which is formed from a flat spring on the surface 743 opposed to the housing 721. The lock part 744 is designed to apply pressure by a force of spring, on a plane 723 of the housing 721 which is opposed to the support part 740, when the support part 740 is rotatably mounted on the housing 721.

The plane 723 opposed to the support part 740 of the housing 721 is provided with a concave part 724 on the path where the lock part 744 comes into contact with the plane 723 when the support part 740 moves rotationally about the housing 721.

This concave part 724 is provided on a position, which allows the lock part 744 to come into contact with the concave part in the case where the display part 160 is located at a position opposed to the head mounted band 710.

This lock part 744 operates on the concave part 724 by entering the inner side of the concave part 724 by the elasticity of the flat spring, and the lock part locks the rotation of the support part 740.

The size and shape of the lock part 744 and the concave part 724 may be appropriately designed, within a range that allows the support part 740 to lock the rotation when the display part 160 is rotated and reaches a position opposed to the head mounted band 710, and within a range that allows the lock part 744 to be detached from the concave part 724 when the support part 740 is rotated relative to the housing 721 with a certain force.

The support part 740 is fixedly coupled with one end of the arm part 750, and the other end of the arm part 750 is coupled with the display part 160.

The configuration of the present embodiment is identical to that of the first embodiment, except that the arm part 750 is fixed on the support part 740, and unlike the first embodiment, the arm part 750 has a longitudinal section having a rectangular shape.

In addition, the display part 160 and the controller 180 are the same as the first embodiment.

Since the head mounted display 700 relating to the present embodiment is configured as described above, a portion for locking the rotation of the support part 740 and the display part 160 hides inside the support part 740 and the housing 721 of the speaker 720A. Therefore, this configuration achieves a superior appearance, as well as preventing damage and enhancing portability, because such portion is not exposed outwardly.

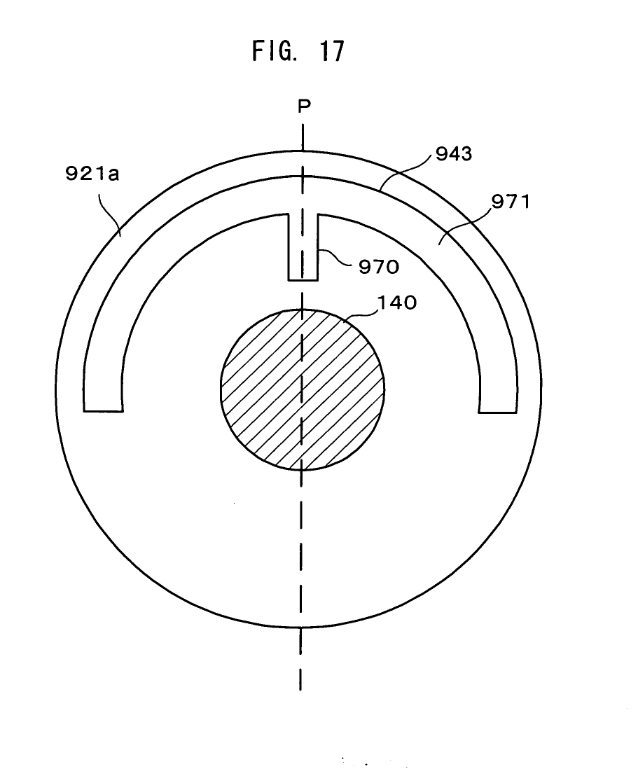

FIG. 16 is a perspective view of a head mounted display 900 according to a fifth embodiment of the present invention.

As illustrated, the head mounted display 900 is provided with a head mounted band 910, speakers 920A and 920B, a display circuit 330, a support part 140, an arm part 950, a display part 360, and a controller 980. Since the head mounted band 910, the arm part 950, and the speaker 920A are different from those of the second embodiment, explanations will be made as to the points relating to the differences.

As illustrated, the wall surface 921a of the housing 921 on the support part 140 side of the speaker 920A, is provided with a cam groove 943, unlike the second embodiment.

Firstly, the cam groove 943 will be explained. FIG. 17 is an illustration of the speaker 920A viewed from the direction indicated by the arrow A in FIG. 16.

The cam groove 943 is generated in such a manner as forming a concave toward inside of the housing 921, dented from the wall surface 921a of the housing 921 on which the support part 140 is installed.

The cam groove 943 is made up of a rotation groove portion 971 and a slide groove portion 970.

The longitudinal direction of the rotation groove portion 971 is formed in a circular arc shape about a rotation center of the support part 140.

The slide groove portion 970 is formed in a manner as extending toward the rotation center of the support part 140, from a middle position between both ends of the rotation groove portion 971 in the longitudinal direction. The internal space of the rotation groove portion 971 and the internal space of the slide groove portion 970 are formed in such a manner as generating a continuous internal space.

The size and shape of the concave part of the cam groove 943 are formed so that a cam follower 981 described below is allowed to be inserted therein.

It is to be noted that this cam groove 943 is formed so as to be symmetrical placing the head mounted band 910 therebetween. The configuration as described above allows the display part 360 to be movable symmetrically relative to the head mounted band 910, and thereby enabling the positioning of the display part 360 at any of the either places, in front of the user's right eye or the left eye.

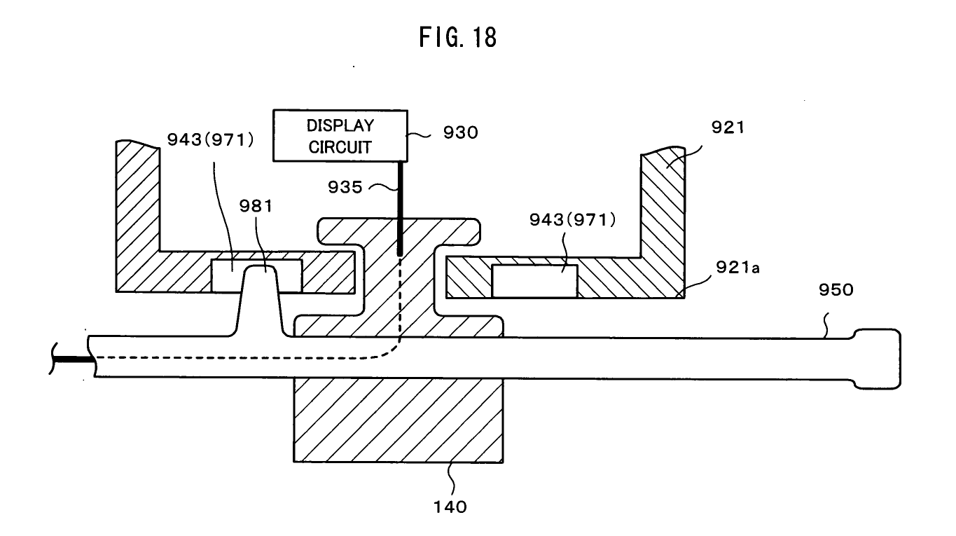

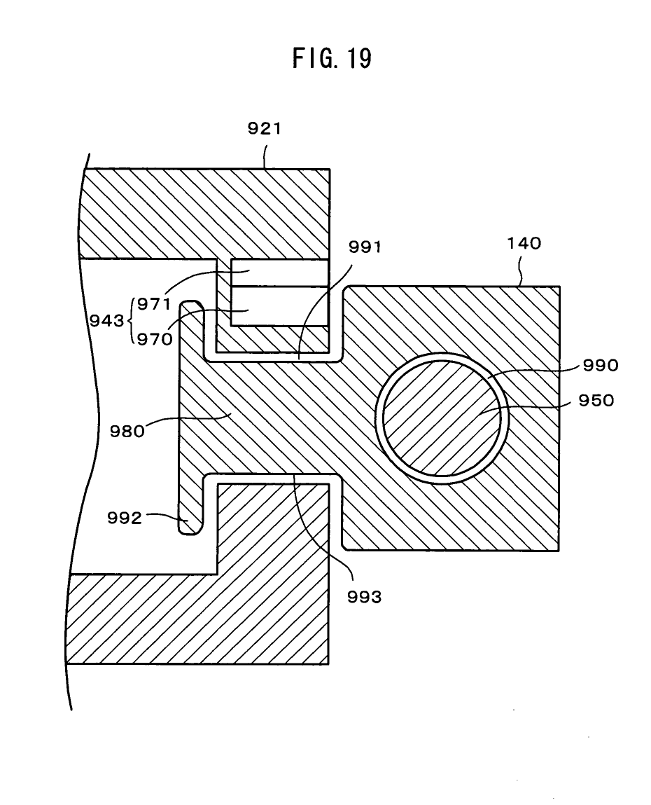

Next, the arm part 950 will be explained. FIG. 18 is a transverse sectional view on the line B-B′ of FIG. 16, viewed from the direction indicated by arrows, and FIG. 19 is a longitudinal sectional view on the line C-C′ of FIG. 16, viewed from the direction indicated by arrows.

As illustrated in FIG. 18, the arm part 950 is provided with the cam follower 981.

The cam follower 981 is formed in a shape of convex projecting from the arm part 950 directed to the housing 921 of the speaker 920A, and the cam follower 981 is formed with a size and shape that allows the cam follower to be inserted into the cam groove 943 which is provided on the housing 921.

Here, the reference numeral 935 indicates a signal line that supplies a video signal and a power supply from the display circuit 930 via the arm part 950 to the display part 360.

The cam follower 981 is inserted into the cam groove 943, and when the arm part 950 is moved rotationally about the support part 140 toward the head mounted band 910, the cam follower is designed in such a manner as movable along in the rotation groove portion 971.

On the position where the head mounted band 910 is opposed to the display part 360, the arm part 950 is displaced toward the support part 140, so that a distance between the display part 360 and the head mounted band 910 becomes narrower, whereby the cam follower 981 is moved to the slide groove portion 970.

When the cam follower 981 is located inside the slide groove portion 970, the cam follower 981 comes into contact with the inner surface of the slide groove portion 970 and restricts the rotation of the arm part 950, even though the arm part 950 is tried to move rotationally relative to the head mounted band 910.

When the cam follower 981 is located inside the slide groove portion 970, it is possible to displace the arm part 950 relative to the support part 140, so that the distance between the display part 360 and the head mounted band 910 becomes wider. Accordingly, the cam follower 981 can be moved from the slide groove portion 970 into the inner side of the rotation groove portion 971. This position allows the arm part 950 to move rotationally relative to the head mounted band 910.

The locking means of the display part 360 relating to the present embodiment operates as the following; when the display part 360 is located at a position opposed to the head top of the head mounted band 910 or in proximity thereto, the arm part 950 is made to slide towards the support part 140 and displaced in the direction to make the distance between the display part 360 and the head mounted band 910 become narrower, and the rotation of the arm part 950 is suppressed by the sidewalls of the vertical slide groove portion 970.

The display part 360 has a sensor 363, and since this is the same as the sensor of the second embodiment, detailed explanation thereof will not be given here.

As thus described, according to the head mounted display 900 relating to the present embodiment, there is an effect similar to the second embodiment, and in addition, the distance between the display part 360 and the head mounted band 910 becomes narrower, thereby suppressing an intrusion of foreign matter between the display part and the head mounted band and preventing the surface for displaying an image from being scratched.

It is further desirable that the display part 360 is displaced until it adheres tightly to the head mounted band 910, because this may further prevent the display part 360 from being damaged.

Any of the embodiments described above illustrate a head arm type, which puts the head mounted band at the top of the user's head. However, the present invention is not limited to this example, and a rear arm type may be available, which puts the head mounted band at the back of user's head, for instance.

In each of the embodiments described above, a columnar arm part is inserted into the columnar through-hole provided on the support part, and the arm part is made slidable to the support part, whereby the distance between the display part and the head mounted band can be changed. However, the present invention is not limited to this example. For instance, an arm part may be used, which is provided with a first tubular member and a second tubular member having an inner periphery in contact with the outer periphery of the first tubular member, and the length of the arm can be changed by sliding these tubular members, or an arm part may be used, which incorporates at least a portion where a so-called bellows structure is provided, and accordingly, this structure allows the distance between the display part and the head mounted band to be variable.

In each of the embodiments described above, the arm part is coupled rotatably with one speaker via the support part. However, the present invention is not limited to this example. For instance, it is possible to couple the arm part rotatably with the head mounted band via the support part.

Further in each of the embodiments described above, it is designed so that the display part can be fixedly held by an elastic deformation of the restraint part or the friction force between the restraint part and the arm part. However, the present invention is not limited to this example. For instance, a magnet is provided on either of the restraint part and the display part (or the arm part), and a magnetic material such as iron is provided on the other. Accordingly, it is possible to hold the display part fixedly by the magnetic force.

It is to be noted here that each of the embodiments of the present invention is directed to the head mounted display of a type for viewing an image with one eye. However, the present invention may be applied to a head mounted display of a type for viewing an image with both eyes.

1. A head mounted display, comprising,
a head mounted band wearable on a head, and a display part being installed in such a manner as rotatable relative to the head mounted band, wherein,
a locking means is provided for locking a rotational movement of the display part when the display part is located at a position opposed to a top of the head or in proximity thereto of the head mounted band.

2. The head mounted display according to claim 1, wherein,
the locking means locks the rotational movement of the display part by moving the display part in the direction in which a distance between the display part and the head mounted band becomes narrower, when the display part is located at a position opposed to the top of the head or in proximity thereto of the head mounted band.

3. The head mounted display according to claim 1, comprising a speaker at least on one end of the head mounted band, wherein,
the locking means is a restraint part that is provided on the speaker.

4. The head mounted display according to claim 1, wherein,
the locking means is provided on a rotation control part for moving the display part rotationally.

5. The head mounted display according to claim 1,
the locking means is a restraint part that is provided on the head mounted band.

6. The head mounted display according to claim 3, comprising an arm part that is equipped with the display part on one end, and the other end of the arm part is rotatable relative to the head mounted band, wherein,
the restraint part has a fitting part in a path of the arm part that moves rotationally, for fitting a portion of the arm part into the restraint part.

7. The head mounted display according to claim 3, wherein,
the restraint part restrains the rotational movement of the display part at a position where the display part and the head mounted band are opposed to each other.

8. The head mounted display according to claim 5, comprising, an arm part that is equipped with the display part on one end, and the other end of the arm part is rotatable relative to the head mounted band, a distance between the display part and the head mounted band being changeable, wherein,
the display part is moved rotationally relative to the head mounted band so as to be brought closer to the head mounted band at a position where the display part and the head mounted band are opposed to each other, thereby allowing the restraint part to restrain the rotational movement of the display part.

9. The head mounted display according to claim 5, wherein,
the head mounted band has a storage for storing therein at least a part of the display part, and the storage forms the restraint part.

10. The head mounted display according to claim 9, wherein,
the storage has at least two surfaces being opposed to each other, allowing the display part to be put between the two surfaces.

11. The head mounted display according to claim 9, wherein,
the head mounted band is formed in such a manner that at least two members are arranged side by side, and the storage is located between the two members.

12. The head mounted display according to claim 5, wherein,
the head mounted band is provided with a circuit for processing an image that is displayed in the display part.

13. The head mounted display according to claim 5, wherein,
the head mounted band is provided with a pair of speakers.

14. A head mounted display comprising a head mounted band and a display part mounted in such a manner as rotatable relative to the head mounted band, wherein,
the head mounted band has a storage for storing at least a part of the display part therein.
